(19) United States
(12) Patent Application Publication
(10) Pub. No.: US 2012/0173688 A1
(43) Pub. Date: Jul. 5, 2012

(54) METHOD AND SYSTEM FOR IMPROVED NETWORK MAINTENANCE SCHEDULING

(75) Inventors: Sandra L. True, St. Charles, IL (US); Frank H. Smith, Aurora, IL (US)

(73) Assignee: Alcatel-Lucent USA Inc

(21) Appl. No.: 12/983,949

(22) Filed: Jan. 4, 2011

(51) Int. Cl. G06F 15/173

(52) U.S. Cl. 709/223

(57) ABSTRACT

A network maintenance scheduling conflict interceptor that prevents duplicate and conflicting work from occurring on any network elements, which make up a network system, so that costly and disruptive outages do not occur in the network system by allowing for an intelligent way to schedule and complete maintenance activities in a complicated network is provided. This new device enables the necessary communication between network elements that allows for communication of maintenance activities taking place on specific network elements that may impact other network elements in the network. Lastly, by nature of providing for a mechanized way to schedule network maintenance activities, the new device, in essence, captures and provides for a history of maintenance activities for a network. Such historical data can provide valuable information for future network planning and maintenance.

### FIELD OF INVENTION

The inventions herein relate to a method and system for improving maintenance scheduling. While embodiments of the invention are particularly directed to the art of telecommunications and network maintenance scheduling, and will be thus described with specific reference thereto, it will be appreciated that other embodiments of the invention may have usefulness in other fields and applications.

### BACKGROUND OF THE INVENTION

By way of background, within telecommunications networks such as the Universal Mobile Telecommunications System (UMTS), scheduled maintenance activities take place on multiple network elements, which may have an adverse effect on the overall health of the network. In particular, such maintenance activities may cause unplanned outages, thus resulting in end-customer dissatisfaction and penalty fees being imposed on equipment makers by service providers. Typically, electronic calendars are utilized in an attempt to avoid these detrimental effects of networks maintenance.

### SUMMARY OF THE INVENTION

Network outages and resulting penalties could be avoided if the maintenance activities are coordinated among the impacted network elements and not performed in an overlapping manner. While existing electronic calendars may be used to document maintenance activities, this internal, manual methodology of simply logging planned work on an electronic calendar fails on various levels. In particular, this methodology does not prevent conflicting work from being executed simultaneously. For example, it does not communicate the maintenance events to network elements that could be impacted by the maintenance task. It does not handle changes to maintenance tasks easily or receive information from technicians regarding the completion status of the scheduled events. It does not have tie-ins to the network elements that are being maintained in the network. It does not incorporate all of the network elements that could be part of a network.

The technical problem of designing, implementing and integrating intelligent hardware and software functionality that allows for maintenance activity management, determines potential conflicts when maintenance is being performed on network elements, communicates scheduled maintenance activities to impacted network elements, and prevents overlapping maintenance activities from being performed needs to be solved. Accordingly, embodiments of the invention contemplate a new and improved method and system that resolves one or more of the above-referenced difficulties and others.

As described herein, the new network maintenance scheduling conflict interceptor prevents duplicate and conflicting work from occurring on network elements, which make up a network system. By allowing for an intelligent way to schedule and complete maintenance activities in a complicated network, costly and disruptive outages in the network system may be reduced or prevented. In addition, the network maintenance scheduling conflict interceptor enables the necessary communication between network elements that allows for communication of maintenance activities taking place on specific network elements that may impact other network elements in the network. Lastly, the network maintenance scheduling conflict interceptor captures a history of maintenance activities for a network. Such historical data can provide valuable information for future network planning and maintenance activities.

The network maintenance scheduling conflict interceptor suitably includes a hardware and software-based system with a centralized scheduling console and is configured to register, aggregate, interpret, disseminate, and track maintenance work on the network system. The network maintenance scheduling conflict interceptor can be an independent hardware and software configuration or it can be implemented in and reside in a network node of an existing Network Level Management system connected to all the network elements in the network.

In one embodiment, a processor-based system for intercepting and resolving conflicts in network maintenance task scheduling is provided. The system generally includes a network maintenance scheduling conflict interceptor system in communication with one or more network maintenance scheduling manager consoles and configured to provide a Web-based tool for resolving conflicts in the scheduling of network maintenance tasks. The system may further include a network maintenance scheduling conflict interceptor database that is connected to the network maintenance scheduling conflict interceptor system and is configured to store network maintenance data.

The network maintenance scheduling conflict interceptor system may further include one or more of the following modules: a system initialization module, a schedule maintenance task module, a prepare for execution of scheduled maintenance task module, an execute scheduled maintenance task module, a mark maintenance task completed module, and/or a report maintenance task module.

In another embodiment, a computer program product is provided. The computer program product comprises a non-transitory computer-usable data carrier storing instructions that, when executed by a computer, cause the computer to provide a Web-based network maintenance scheduling conflict interceptor system. The network maintenance scheduling conflict interceptor system may include various modules, such as a system initialization module, a schedule maintenance task module, a prepare for execution of scheduled maintenance task module, an execute scheduled maintenance task module, a mark maintenance task completed module, and/or a report maintenance task module, or a combination of these modules.

In yet another embodiment, a network maintenance scheduling method is provided. The method includes: receiving via a first module initial set-up data including network topology data, maintenance task data, conflict data, and technician data; receiving via a second module data relating to a scheduled maintenance task for a network element in at least one market; sending via a third module a message to impacted network elements, the message containing information relating to one or more maintenance tasks that are to be started; verifying via a fourth module that the maintenance task to be started has been scheduled; receiving via a fifth module an updated status of the maintenance task; and creating via a sixth module one or more maintenance reports for historical analysis and/or business planning.

Further scope of the applicability of embodiments of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of a telecommunication system featuring a network maintenance scheduling conflict interceptor system in accordance with aspects of one embodiment of the present invention;

FIG. 2 is a block diagram of an example network maintenance scheduling conflict interceptor system;

FIG. 3 is a flow chart illustrating the basic operation of the schedule maintenance task module of FIG. 2;

FIG. 4 is a flow chart illustrating the basic operation of the prepare for execution of scheduled maintenance task module of FIG. 2;

FIG. 5 is a flow chart illustrating the basic operation of the execution of scheduled maintenance task module of FIG. 2;

FIG. 6 is a flow chart illustrating the basic operation of the mark maintenance task completed module of FIG. 2; and

FIG. 7 is a flow chart illustrating the basic operation of the report maintenance tasks module of FIG. 2.

### DETAILED DESCRIPTION

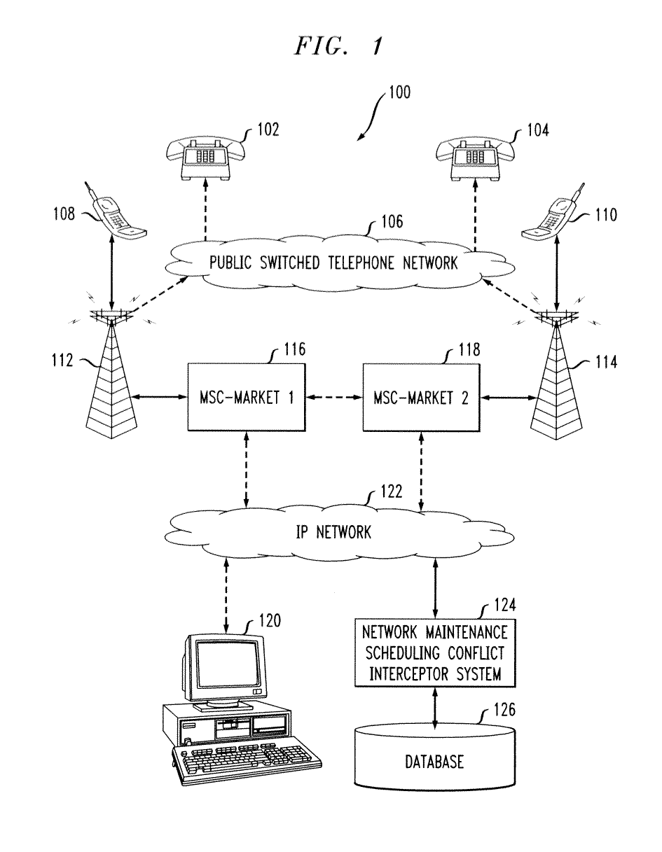

Referring now to the drawings wherein the showings are for purposes of illustrating the exemplary embodiments only and not for purposes of limiting the claimed subject matter, FIG. 1 provides a view of an exemplary telecommunications system 100 into which the presently described embodiments may be incorporated. As shown generally, the system 100 may include various communications devices such as wireline telephones (102, 104) connected to the public switched telephone network (PSTN) 106, wireless devices (108, 110) connected to corresponding base stations (112, 114), mobile switching centers (116, 118), and at least one network maintenance scheduling manager console 120 having a graphical user interface (GUI) and connected to the mobile switching centers (116, 118) through an IP network 122.

Further, the system 100 includes a network maintenance scheduling conflict interceptor system 124 and a corresponding network maintenance scheduling conflict interceptor database 126. Suitably, the network maintenance scheduling conflict interceptor system 124 provides a Web-based tool for resolving conflicts in the scheduling of maintenance tasks, which can be accessed by any of the communication devices having Internet browsing capabilities, including the graphical user interface of the network maintenance scheduling manager console 120. The network maintenance scheduling conflict interceptor database 126 stores data relating to the scheduling of maintenance tasks as described more fully below.

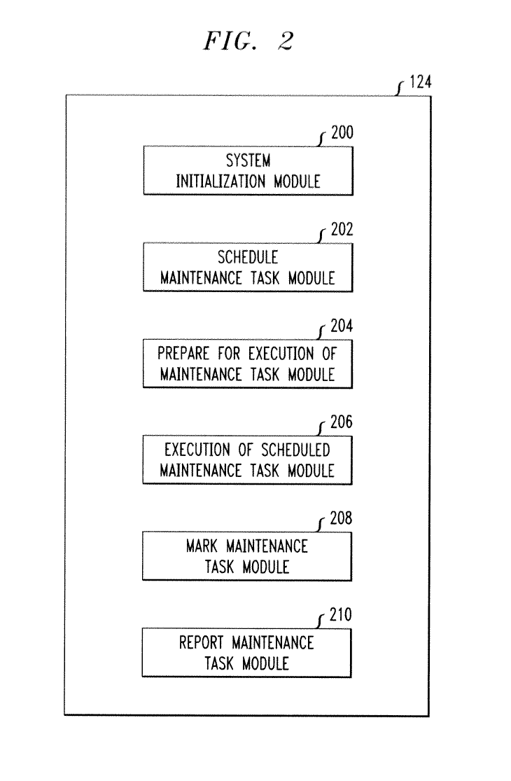

As shown in FIG. 2, the basic components of the network maintenance scheduling conflict interceptor system 124 may include, among other things: a system initialization module 200, a schedule maintenance task module 202, a prepare for execution of scheduled maintenance task module 204, an execution of scheduled maintenance task module 206, a mark maintenance task completed module 208, and a report maintenance tasks module 210.

It is to be understood that the functions of the various elements shown in the figures, including any functional blocks labeled as “modules,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, the particular technique being selectable by the implementer as more specifically understood from the context.

The system initialization module 200 may be configured to allow for the initial set-up of network topology, maintenance task information, conflict data, and technician data, among other things. Data regarding the network topology could be received, for example, via the graphical user interface of the network maintenance scheduling manager console 120 or it could be automatically discovered using existing techniques. The data could also be bulk loaded from an OSS level XML feed. Data relevant to the network topology could include, for example: Market ID, Network Element ID, dependents, dependency type (i.e., northbound, southbound, horizontal), IP addresses of interfaces, and the like. Network topology could be shown on the network maintenance scheduling conflict interceptor tool using a tree structure or a graphical topology map. Such data may be stored in the network maintenance scheduling conflict interceptor database 126.

Maintenance task information may be received via the graphical user interface of the network maintenance scheduling manager console 120. Each valid maintenance task may be defined in the system along with other related data such as maintenance code(s), task description, estimated task duration, necessary technician skill level, Method of Procedure (MOP) document associated with task, impacted network element types, and the like.

Technician data could also be received via the graphical user interface of the network maintenance scheduling manager console 120. Before a technician can perform maintenance on a network element, the technician should be defined in the system. Relevant technician data may include, for example: technician name, technician contact info such as home phone, cell phone, work phone, and email address(es), technician skill level, notification preferences, etc.

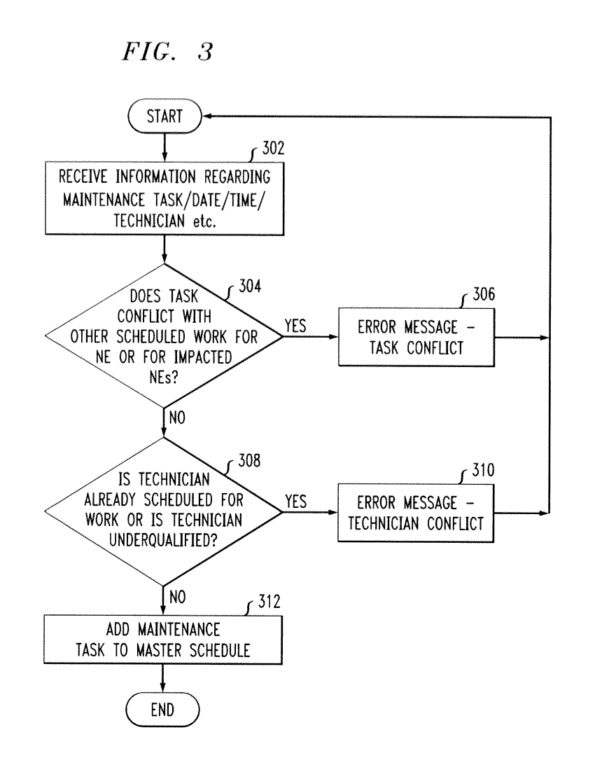

Conflict data could also be received via the graphical user interface of the network maintenance scheduling manager console 120. Conflict data is checked whenever a maintenance task is scheduled, as described more fully below (see FIG. 3 and the accompanying description). The conflict data generally includes information such as (a) each particular maintenance task that can be performed on the system, (b) other network elements that may be affected by performing that task on the system, and/or (c) a list of other maintenance tasks that cannot be performed at the same time. Of course, it is to be understood that this is not an exhaustive list and that other types of information may be used in determining maintenance conflicts. By way of example, a software upgrade or patch of the LCP (Linux Control Platform) in the 3G-MSC Core Network is a task that can affect network elements such as the media gateways, the media resource function element, the OMC-CN (Operations Management Console—Core Network) at a network management level, and the Node B's connected to that core. Therefore, no other maintenance activities can take place when the LCP in the Core Network is being upgraded or patched. In contrast, when performing a growth operation on a media gateway, there would only be a conflict if a software upgrade was performed on a Node B serving that network or if a WSS7 LCP2 blade to LCP3 blade conversion was being performed at the same time. So other tasks on other elements in the network could be scheduled in parallel to the MGW growth task. Conflict data such as this may be consulted when determining if the maintenance task(s) can be performed at the same time as other previously scheduled tasks. For example, maintenance of a network element of type X may affect one or more other network elements. In that case, network elements of type Y and type Z may be consequentially affected by maintenance of network element type X.

With reference now to FIG. 3, the schedule maintenance task module 202 allows for the scheduling a maintenance task for a specific network element. The network element may be located in a specific market. Via the network maintenance scheduling manager console 120 graphical user interface (GUI), information relating to each maintenance task is received (302). The GUI may be configured to allow a technician to directly enter the information and/or make one or more selections from a series of drop-down menus. Such information may include, but is not limited to, the following types:

a. Network Element Identifier

b. Network Element Description

c. Market Identifier

d. Maintenance Code—(note that when a “maintenance code” input is received, items “e” through “I” below may then be populated by the system 124 and displayed to the console operator)

e. Maintenance Task Description

f. Method of Procedure (MOP) Document associated with the maintenance task

g. Impacted Network Elements—(i.e., a list of network element types that may be affected by the maintenance task)

h. Estimated task duration time

i. Suggested Technician Skill Level to complete the task

j. Time/Date/Time Zone for each task to be performed

k. Technician Name—(note that when a Technician Name is received, items “l” and “m” below may then be populated by the system and displayed to the console operator)

l. Technician Contact Information

m. Technician Skill Level

n. Task Status—Scheduled, In-Progress, Not Completed-Errors Encountered, Completed

The foregoing information may be stored in the network maintenance scheduling conflict interceptor database 126 or other suitable database. Based on the received maintenance task information, the network maintenance scheduling conflict interceptor system 124 checks the database 126 for errors and conflicts according to one or more tests. That is, one or more task conflict checks, such as those listed below, may be performed (304):

a. Does the task conflict with other tasks being performed on that same network at the same time and date?

b. Does the task impact other network elements that are also being impacted by other scheduled maintenance activities during the same time frame?

In the event that it is determined that one or more task conflicts exist, then an error message is displayed (306).

If there are no task conflicts, then one or more technician checks, such as those listed below, are performed (308):

a. Does the scheduled technician have an overlapping task scheduled during the same time and date range?

b. Is the scheduled technician qualified to perform the maintenance work based on their skill level?

In the event that it is determined that one or more technician conflicts exist, then an error message is displayed (310).

Provided that all conflicts and errors are resolved, the maintenance task is typically stored in a database containing the Master Schedule records, such as the network maintenance scheduling conflict interceptor database 126 (312).

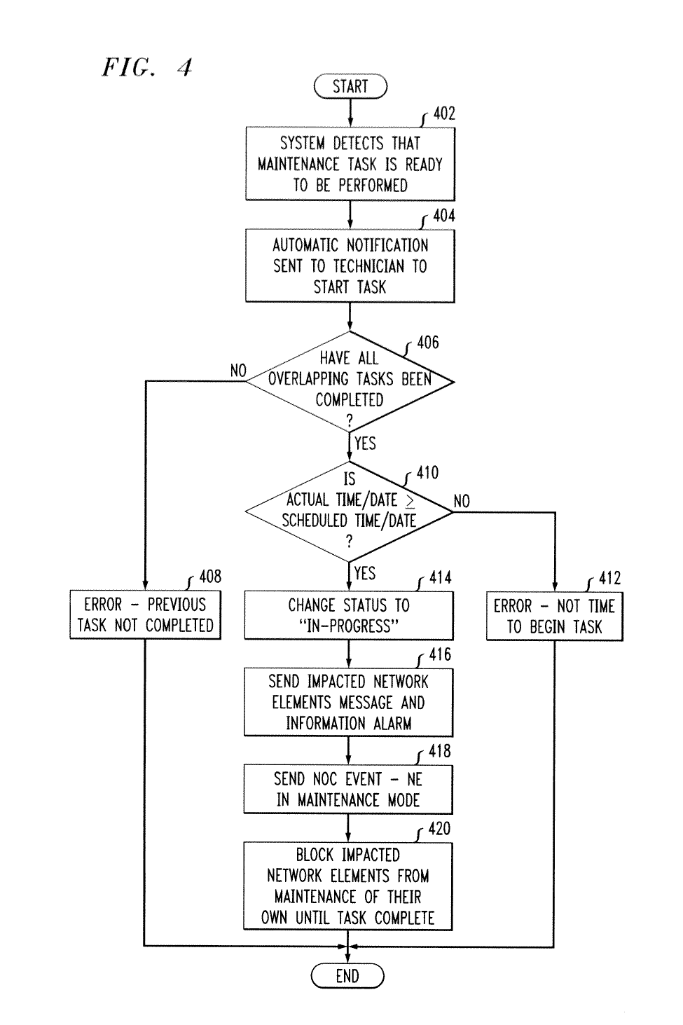

With reference now to FIG. 4, the prepare for execution of scheduled maintenance task module 204 communicates to impacted network elements information relating to particular maintenance tasks that are in the process of being started. The expected duration of the maintenance activity may also be communicated for that network's awareness and planning purposes.

The network maintenance scheduling conflict interceptor system 124 is typically adapted to access the database 126 and to detect the upcoming time and date of a scheduled maintenance task (402). At a configurable time period (e.g., one day, one hour, 30 minutes, etc.) prior to the task start time and date, a notification may be provided to the defined contacts for the impacted network elements, indicating that the task is to be started (404). Additionally, a notification may be provided to the scheduled technician, indicating that the maintenance task should be started. These notifications can be in the form of email alerts, text alerts, automated phone messages, or any other type of alerting mechanism. The notification time period before the task is to be started may be a configurable system parameter.

The system 124 then determines whether all previous overlapping tasks have been completed (406). If not, then an error message indicating that all previous tasks have not been completed is displayed to the technician via the GUI (408). Otherwise, a further determination is made as to whether the actual time and date is greater than or equal to the scheduled task time and date (410). If not, then an error message indicating that it is not time to begin the task may be displayed to the technician (412). The technician also may be advised to reschedule the task if it should be started early.

If the actual time and date is equal to or greater than the scheduled task time and date, then the technician may be requested to manually change the status of the maintenance task to “in-progress” via the GUI (414). In another embodiment, the system can be set up to perform this step automatically as part of the MOP document used to perform the maintenance task (414).

Additionally, the impacted network elements are typically sent an informational alarm indicating that the task is now “in-progress” (416). Further, the Network Operations Center (not shown) may be sent an event message, indicating that the network element is in maintenance mode (418). As used herein, the term “Network Operations Center” (or NOC) refers to a location from which control is exercised over the telecommunications network. Service providers may utilize more than one NOC, either to manage different networks or to provide geographic redundancy in the event of one site being unavailable or offline, NOCs are generally responsible for monitoring the telecommunication network for alarms or certain conditions that may require special attention to avoid impact on the network's performance. In this regard, NOCs are typically responsible for monitoring for power failures, communication line alarms (such as bit errors, framing errors, line coding errors, and circuits down) and other performance issues that may affect the network. NOCs analyze problems, perform troubleshooting, communicate with site technicians and other NOCs, and track problems through resolution. If necessary, NOCs escalate problems to the appropriate personnel.

Finally, impacted network elements may be blocked from undergoing maintenance of their own until the task that is in-progress has been completed (420). For example, this feature can be implemented using existing Simple Network Management Protocol (SNMP) over User Datagram Protocol (UDP) interfaces that employ standard interface definitions via a Management Information Base (MIB). Further, a new MIB could be set up to initiate the block on the impacted network element such that the affected network element can be prevented from having any maintenance performed on it until the block has been lifted.

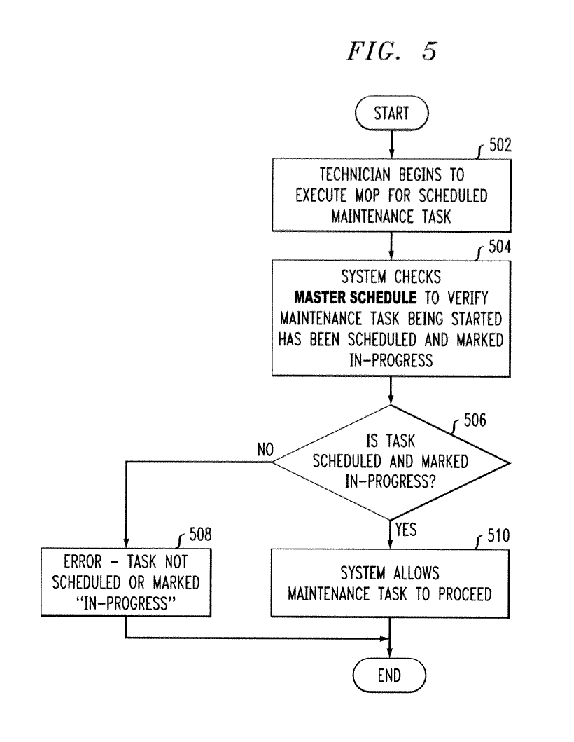

With reference now to FIG. 5, the execute scheduled maintenance task module 206 generally verifies that the maintenance task to be started has indeed been scheduled in the system. This module is also responsible for ensuring use of the network maintenance scheduling conflict interceptor system 124 for maintenance tasks. Initially, the technician would begin to execute the MOP (Method of Procedure document) for the scheduled maintenance task, which event is communicated to the network maintenance scheduling conflict interceptor system 124 (502). As part of the MOP, a check is initiated from the network element to the network maintenance scheduling conflict interceptor system 124 to obtain the status of the maintenance task from the Master Schedule in the database 126 (504). A determination is then made as to whether the maintenance task has been scheduled and marked as being “in-progress” (506). This cross check is helpful in that it will be more difficult for technicians to bypass the network maintenance scheduling conflict interceptor system 124, which is imperative for preventing conflicts that can cause outages. If not, then an error message is displayed to the technician indicating that the task has not been scheduled and/or marked as being “in-progress” (508). In particular, if the task has not been scheduled, the technician will be provided with an opportunity to enter the task into the scheduling system before proceeding with the maintenance work. Otherwise, the system 124 allows the maintenance task to proceed (510).

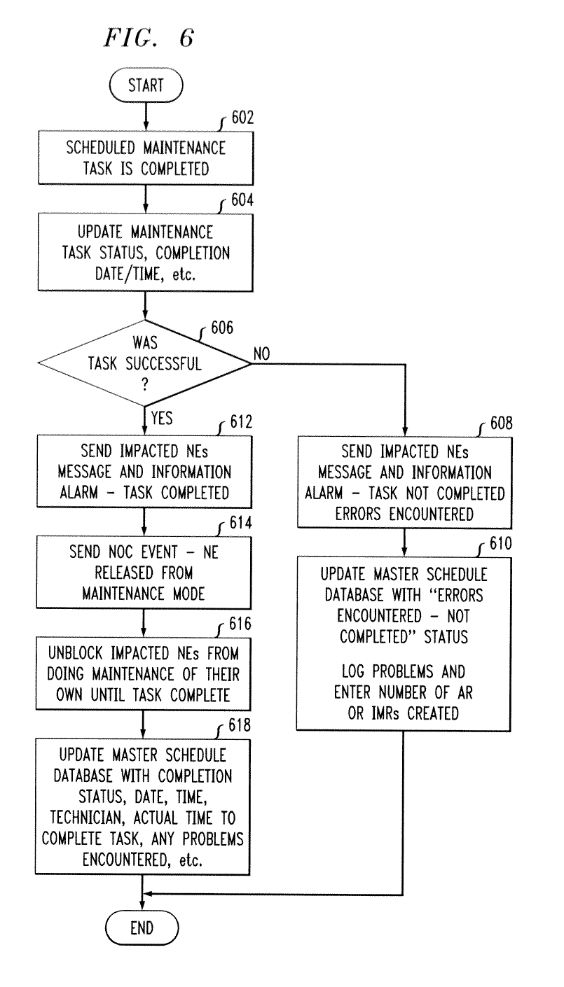

With reference now to FIG. 6, the mark maintenance task completed module 208 allows for updating the status of the maintenance activity. Such information may be stored in the network maintenance scheduling conflict interceptor database 126. More particularly, once a task has been completed (602), the system should receive a status update (602), which reflects the outcome of the maintenance activity (604). For example, the system could be set up to perform this step automatically as part of the final steps in the MOP document used to perform the maintenance task (604). In another embodiment, the system may be configured to receive status updates directly from the technician. This status could be reflected, for example, as either “completed” successfully or “Errors encountered—not completed.” A determination is then made by the system as to whether the task was completed successfully (606).

If the task was unable to be completed due to problems encountered, the network elements that may be impacted by the maintenance activity may be sent an Informational Alarm notifying them of the status change of the task (608). Depending on the severity of the errors encountered that caused the task to not be completed, the network elements may be sent an event to release the network elements from maintenance mode if the task can be backed out (such as the case of a software upgrade failing before completion) or they may remain in maintenance mode until the problems can be resolved and the task completed. Also depending on the severity of the errors encountered that caused the task to be not completed, the network elements that were previously blocked from doing any maintenance activities of their own may now be unblocked or left in blocked status until the problems are investigated and resolved and the task can be completed. In addition, the status of the maintenance task would be changed from “in-progress” to “Errors encountered—not completed” (610). Optionally, there could be a data array for receiving data relating to any problems or errors encountered during the maintenance task. A tie-in to an existing ticketing system for managing network issues/problems could be provided that would link the maintenance activity to any tickets created or resulting from the unsuccessful completion of the scheduled maintenance task. The task could also be rescheduled for a later time/date and be linked to the initial task that was not completed due to errors.

If the task was completed successfully, the network elements that were impacted by the maintenance activity are sent an Informational Alarm notifying them that the task has been completed (612). The NOC is sent an event message to release the network elements from maintenance mode (614). The network elements that were previously blocked from doing any maintenance activities of their own may now be unblocked (616). The Master Schedule record should be updated with an indication that the task has been completed. The record may also be updated with additional information relating to the task, such as the actual time and date of the completed maintenance task, the technician who performed the work (which may be different from the technician who was scheduled to do the work), the amount of time it took to complete the task (which may be different from the estimated amount of time to complete the task), etc. (618). In addition, a data array for entering and documenting any problems or errors encountered during the maintenance task may be presented on the graphical user interface of the network maintenance scheduling manager console 120. A tie-in to an existing ticketing system could be provided that would link the maintenance activity to any tickets created or resulting from the maintenance task.

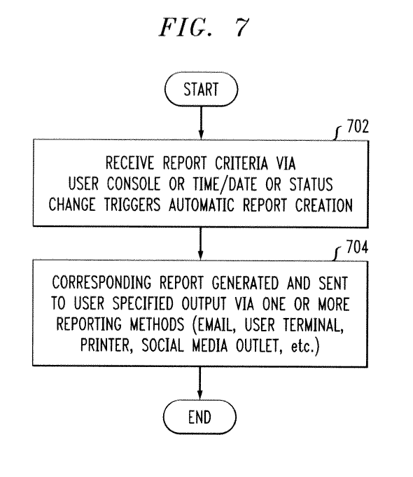

With reference now to FIG. 7, the report maintenance tasks module 210 uses the Master Schedule data in the database 126 to create various types of maintenance-related reports. These reports could be used for various purposes, such as for historical analysis and/or business planning. Initially, the report criteria may be received via the graphical user interface of the network maintenance scheduling manager console 120 (702). Optionally, these reports could be generated automatically based on triggers set up in the system 124. For example, at the start of each work shift, a report of all scheduled maintenance activities for the current day and time period could be generated automatically and e-mailed to the email accounts associated with the network elements in a particular market.

There are various types of reports that could be generated from the Master Schedule database (704). The reports may be based on any combination of a number of variables, including the type of task, the scheduled maintenance time, the scheduled technician, the technician who performed the work, the network element involved, the type of network, the market, a time period for scheduled maintenance, etc.

Thus, the generated reports may include information such as a set of maintenance tasks that are “in-progress,” a set of over-due maintenance tasks, a set of maintenance tasks performed by a specific technician for a specified time period, the maintenance history for a specific network element in a specific market, the maintenance history for a network element type across all markets, and/or a set of network elements that have scheduled maintenance activities for the current day. Of course, it is to be understood that this is not an exhaustive list and that other types of reports may be generated.

The output from these reports could be sent to any number of user defined outlets, such as a printer, a terminal screen, an e-mail address, a phone, social media outlets, and the like.

A person of skill in the art would readily recognize that steps of various above-described methods can be performed by programmed computers. Herein, some embodiments are also intended to cover program storage devices, for example, digital data storage media, which are machine or computer readable and include encoded machine-executable or computer-executable programs of instructions, wherein said instructions perform some or all of the steps of said above-described methods. The program storage devices may be, for example, digital memories, magnetic storage media such as a magnetic disks and magnetic tapes, hard drives, or optically readable digital data storage media. The embodiments are also intended to cover computers programmed to perform said steps of the above-described methods.

The present invention may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

We claim:

1. A processor-based system for intercepting and resolving conflicts in network maintenance task scheduling, the system comprising:
a network maintenance scheduling conflict interceptor system configured for communication with one or more network maintenance scheduling manager consoles and configured to provide a Web-based tool for resolving conflicts in the scheduling of network maintenance tasks; and
a network maintenance scheduling conflict interceptor database connected to the network maintenance scheduling conflict interceptor system and configured to store network maintenance data.

2. The system of claim 1, wherein the network maintenance scheduling conflict interceptor system further comprises one or more of the following modules:
a system initialization module;
a schedule maintenance task module;
a prepare for execution of scheduled maintenance task module;
an execute scheduled maintenance task module;
a mark maintenance task completed module;
a report maintenance task module.

3. The system of claim 2, wherein the system initialization module is configured to receive network topology information, maintenance task information, conflict data, and technician data.

4. The system of claim 2, wherein the schedule maintenance task module is configured to receive maintenance task information.

5. The system of claim 2, wherein the prepare for execution of scheduled maintenance task module is configured to communicate to impacted network elements information that one or more maintenance tasks are to be started.

6. The system of claim 2, wherein the execute scheduled maintenance task module is configured to verify that a maintenance task that is to be started has been scheduled in the system.

7. The system of claim 2, wherein the mark maintenance task completed module is configured to receive updates on the status of the maintenance task.

8. The system of claim 2, wherein the report maintenance task module is configured to use network maintenance data to create maintenance reports.

9. The system of claim 8, wherein a maintenance report comprises one or more of the following types of information: a set of maintenance tasks in-progress; a set of over-due maintenance tasks; a set of maintenance tasks performed by a technician for a specified time period; a maintenance history for a network element in a specific market; a maintenance history for a network element type across all markets; and a set of network elements that have scheduled maintenance activities for current specific day.

10. A computer program product comprising:
a non-transitory computer-usable data carrier storing instructions that, when executed by a computer, cause the computer to provide a Web-based network maintenance scheduling conflict interceptor system that includes:
a system initialization module;
a schedule maintenance task module;
a prepare for execution of scheduled maintenance task module;
an execute scheduled maintenance task module;
a mark maintenance task completed module;
a report maintenance task module.

11. The computer program product of claim 10, wherein the system initialization module is configured to receive network topology, maintenance task information, conflict data, and technician data.

12. The computer program product of claim 10, wherein the schedule maintenance task module is configured to receive maintenance task information.

13. The computer program product of claim 10, wherein the prepare for execution of scheduled maintenance task module communicates to impacted network elements information that one or more maintenance tasks will be started.

14. The computer program product of claim 10, wherein the execute scheduled maintenance task module verifies that the maintenance task to be started has been scheduled in the system.

15. The computer program product of claim 10, wherein the mark maintenance task completed module is configured to receive updates on the status of the maintenance task.

16. The computer program product of claim 10, wherein the report maintenance task module is configured to use network maintenance data to create maintenance reports.

17. The computer program product of claim 16, wherein a maintenance report comprises one or more of the following types of information: a set of maintenance tasks in-progress; a set of over-due maintenance tasks; a set of maintenance tasks performed by a specific technician for a specified time period; a maintenance history for a network element in a specific market; a maintenance history for a network element type across all markets; a set of network elements that have scheduled maintenance activities for a specific day.

18. A network maintenance scheduling method comprising:
receiving via a first module initial set-up data including network topology data, maintenance task data, conflict data, and technician data;
receiving via a second module data relating to a scheduled maintenance task for a network element in at least one market;
sending via a third module a message to impacted network elements, the message containing information relating to one or more maintenance tasks that are to be started;
verifying via a fourth module that the maintenance task to be started has been scheduled;
receiving via a fifth module an updated status of the maintenance task; and
creating via a sixth module one or more maintenance reports for historical analysis and/or business planning.

19. The method of claim 18, wherein a maintenance report comprises one or more of the following types of information: a set of maintenance tasks in-progress; a set of over-due maintenance tasks; a set of maintenance tasks performed by a technician for a specified time period; a maintenance history for a network element in a specific market; a maintenance history for a network element type across all markets; a set of network elements that have scheduled maintenance activities for a specific day.

20. The method of claim 18, wherein the set up data is stored in a network maintenance scheduling conflict interceptor database.
